(19) United States
(12) Patent Application Publication
(10) Pub. No.: US 2016/0072942 A1
(43) Pub. Date: Mar. 10, 2016

(54) DESIGN AND IMPLEMENTATION OF VIRTUAL TTY APPLICATION MANAGER

(71) Applicant: VIA TELECOM CO., LTD., George Town (KY)

(72) Inventor: MEOUNG-JIN LIM, San Diego, CA (US)

(21) Appl. No.: 14/802,252

(22) Filed: Jul. 17, 2015

Related U.S. Application Data
(60) Provisional application No. 62/047,793, filed on Sep. 9, 2014.

(51) Int. Cl. H04M 1/725; H04M 3/42; H04W 4/12

(52) U.S. Cl. CPC H04M 1/72552; H04W 4/12; H04M 3/42391; H04M 1/72591

(57) ABSTRACT

An apparatus for communicating teletype (TTY) messages over a wireless voice link is provided. The apparatus includes a virtual TTY device manager, a display controller, and a keyboard controller. The virtual TTY device manager is disposed within a wireless communication device, and is configured to format first TTY messages for transmission over the wireless voice link, and is configured to extract second TTY messages from frames received over the wireless voice link. The display controller is disposed within the wireless communication device and is coupled to the virtual TTY element, and is configured to present the second TTY messages over a display of the wireless communication device. The keyboard controller is disposed within the wireless communication device and is coupled to the virtual TTY element, and is configured to enable a user to enter the first TTY messages via a keyboard of the wireless communication device.

### CROSS-REFERENCE TO RELATED APPLICATIONS

This application claims the benefit of the following U.S. Provisional Applications, each of which is herein incorporated by reference for all intents and purposes.

| | FILING | |
|---|---|---|
| SER. NO. | DATE | TITLE |
| 62/047,793 | Sep. 9, 2014 | DESIGN AND IMPLEMENTATION |
| (VTU.14-0029-US) | | OF VIRTUAL TTY APPLICATION |
| | | MANAGER |

### BACKGROUND OF THE INVENTION

1. Field of the Invention

This invention relates in general to the field of wireless communications, and more particularly to a design and implementation of a virtual teletype (TTY) application manager for use as a telecommunication device for the deaf (TDD).

2. Description of the Related Art

The wireless communications industry is undergoing exponential growth, not only in this country, but all over the world. In fact, it is well known that the over twenty percent of the adult population in the United States do not even have a traditional landline telephone. In addition to those who do not own a conventional telephone, nearly ninety percent of the adult population owns a wireless phone.

And the usage of cell phones is increasing as well over the use of traditional landline telephone coverage. In fact, one in seven adults now uses only cell phones. Whereas in the past cell phones were used when a landline was not available or under emergency conditions, lower carrier rates, affordability of family packages, and free mobile-to-mobile or friend-to-friend promotions have fostered in significant increases in usage. It is not uncommon today to walk into any public forum or facility and notice a majority of the people there talking on their cell phones.

The ability to communicate using a mobile phone, or mobile station, has been available since the middle of the last century. However, during the 1990's so-called “2G” or second generation mobile phone systems were fielded that began the growth in both deployment and usage that we currently enjoy today. These initial systems predominately provided for the routing and reliable servicing of voice calls between parties. And, as one skilled in the art will appreciate, there are a number of timing and latency requirements associated with transmission and reception of voice data in order to maintain quality of service. As such, so-called circuit-switched voice links have been fielded that guarantee this quality of service.

For years, the deaf have been enabled to communicate with other individuals via these circuit-switch links, such as over the public switched telephone network (PSTN), by cabling a teletype (TTY) device to their telephone. The TTY device generally consists of a keyboard for entering messages to transmit, a display for presenting both transmitted messages and received messages to a user, and the hardware and electronics that provide for transmission and reception of these messages through the telephone's voice-switched circuits. And as wireless communication technologies have advanced, as alluded to above, in many instances deaf or otherwise hearing impaired users have replaced their landlines with wireless service. Accordingly, virtually all wireless telephones today provide so-called TTY capabilities. That is, when cabled to a TTY device and placed into a TTY mode, these wireless telephones provide for transmission and reception of TTY messages over wireless voice links.

The above features notwithstanding, the present inventor has observed that it is both disadvantageous and limiting for a deaf or otherwise hearing impaired person to be required to procure, maintain, and travel with a TTY device and interface cable, particularly since most wireless telephones today have both a keyboard and a display.

Accordingly, what is needed is an apparatus and method for TTY communication over a wireless network that eliminates the need for a separate TTY device and interface cable.

What is also needed is a virtual TTY device that is implemented within a wireless telecommunications device.

### SUMMARY OF THE INVENTION

The present invention, among other applications, is directed to solving the above-noted problems and addresses other problems, disadvantages, and limitations of the prior art. The present invention provides a superior technique for providing a virtual TTY within a wireless communication device. In one embodiment, an apparatus for communicating teletype (TTY) messages over a wireless voice link is provided. The apparatus includes a virtual TTY device manager, a display controller, and a keyboard controller. The virtual TTY device manager is disposed within a wireless communication device, and is configured to format first TTY messages for transmission over the wireless voice link, and is configured to extract second TTY messages from frames received over the wireless voice link. The display controller is disposed within the wireless communication device and is coupled to the virtual TTY element, and is configured to present the second TTY messages over a display of the wireless communication device. The keyboard controller is disposed within the wireless communication device and is coupled to the virtual TTY element, and is configured to enable a user to enter the first TTY messages via a keyboard of the wireless communication device.

One aspect of the present invention contemplates an apparatus for communicating teletype (TTY) messages over a wireless voice link. The apparatus includes a wireless communication device, configured to send first TTY messages and to receive second TTY messages over the wireless voice link. The wireless communication device has a virtual TTY device manager, a display controller, and a keyboard controller. The virtual TTY device manager is disposed within a wireless communication device, and is configured to format first TTY messages for transmission over the wireless voice link, and is configured to extract second TTY messages from frames received over the wireless voice link. The display controller is disposed within the wireless communication device and is coupled to the virtual TTY element, and is configured to present the second TTY messages over a display of the wireless communication device. The keyboard controller is disposed within the wireless communication device and is coupled to the virtual TTY element, and is configured to enable a user to enter the first TTY messages via a keyboard of the wireless communication device.

Another aspect of the present invention comprehends a method for communicating teletype (TTY) messages over a wireless voice link. The method includes: via a virtual TTY device manager disposed within a wireless communication device, formatting first TTY messages for transmission over the wireless voice link, and extracting second TTY messages from frames received over the wireless voice link; presenting the second TTY messages over a display of the wireless communication device; and enabling a user to enter the first TTY messages via a keyboard of the wireless communication device.

### BRIEF DESCRIPTION OF THE DRAWINGS

These and other objects, features, and advantages of the present invention will become better understood with regard to the following description, and accompanying drawings where:

FIG. 1 is a block diagram illustrating present day TTY communication equipment;

FIG. 2 is a block diagram depicting details of the present day near end TTY communication equipment;

FIG. 3 is a block diagram featuring virtual TTY communication equipment according to the present invention;

FIG. 4 is a block diagram showing a virtual TTY communication device according to the present invention; and

FIG. 5 is a block diagram illustrating one embodiment of a virtual TTY communication device according to the present invention.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business related constraints, which vary from one implementation to another. Furthermore, it will be appreciated that such a development effort might be complex and time consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

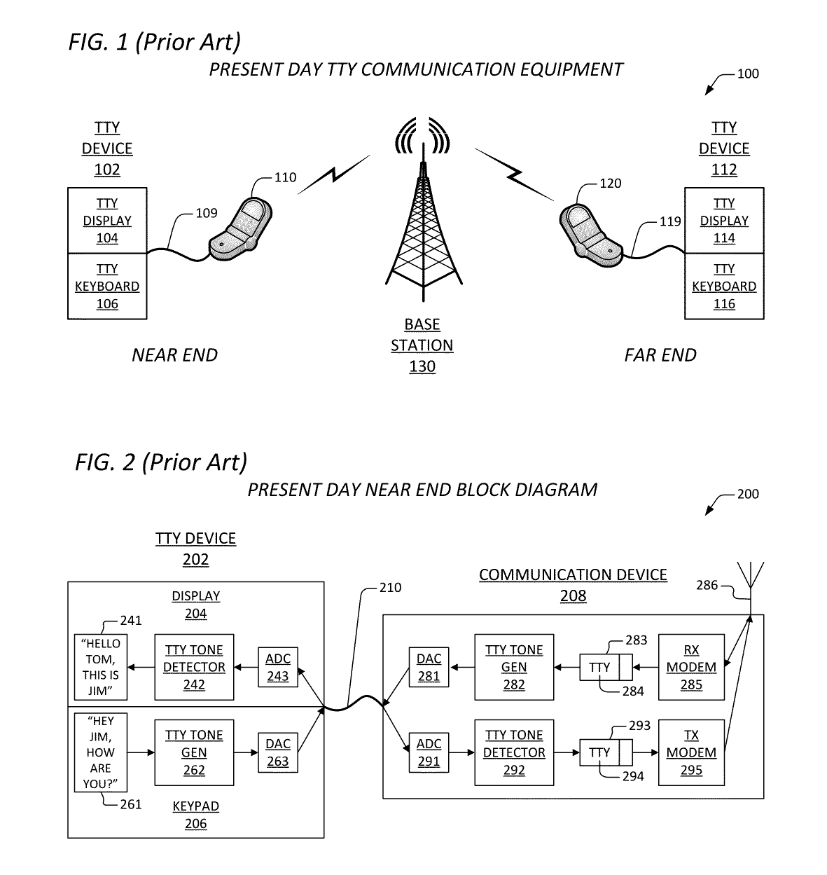

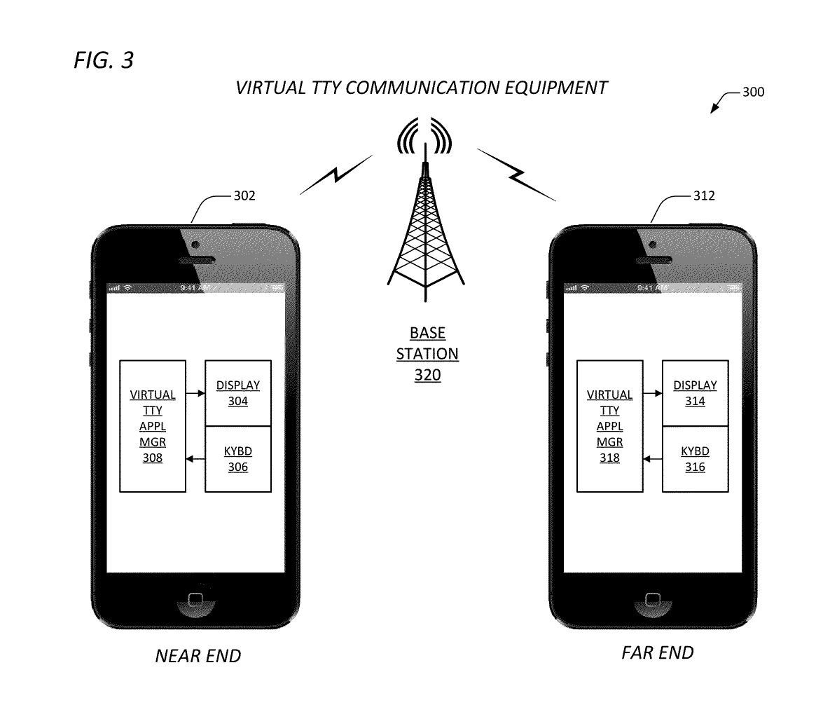

In view of the above background discussion on present day mechanisms that provide telecommunications for the deaf or otherwise hearing-impaired people, a discussion of these mechanisms and their attendant disadvantages and limitations will be presented with reference to FIGS. 1-2. Following this, a discussion of the present invention will be presented with reference to FIGS. 3-5. The present invention overcomes the limitations of present day TTY communication equipment by providing a virtual TTY application manager that may be employed in a wireless communication device, thereby eliminating requirements to interface the wireless communication device to expensive and bulky TTY devices in order to perfect telecommunications for the deaf person. The virtual TTY application manager may be employed in any wireless communication system that provides for interface with TTY devices.

Turning to FIG. 1, a block diagram is presented illustrating present day TTY communication equipment 100. The equipment 100 may include a near end wireless communication device 110 that is coupled to a near end TTY device 102 via an analog cable 109. The near end TTY device 102 has a TTY display 104 that is coupled to a TTY keyboard 106. The near end wireless communication device 110 communicates with a far end wireless communication device 120 over a wireless network which, for clarity purposes, is depicted as a simple cellular base station 130. The far end communication device 120 is coupled to a far end TTY device 112 via a far end analog cable 119. The far end TTY device 112, like the near end TTY device 102, comprises a far end TTY display 114 and a far end TTY keyboard 116.

In operation, a near end user (not shown) uses the near end keyboard 106 to enter a message for transmission to a far end user (not shown) over the wireless network. The message may be displayed on the near end TTY display 104 as it is being transmitted. The near end TTY device 102 converts the message to an analog signal that is transmitted to the near end wireless communication device 110 over the analog cable 109.

The near end wireless communication device 110 transmits the analog signal carrying the message over the wireless network via conventional TTY message transmission techniques that involve insertion of a TTY tone into the transmission that indicates the contents of the analog signal contains TTY characters, i.e., those characters entered via the near end keyboard 106 by the near end user. The analog signal is thus routed over the network via known circuit-switched mechanisms, where it is delivered to the far end wireless communication device 120.

The far end wireless communication device 120 provides the analog signal (with TTY tone present) to the far end TTY device 112 over the far end analog cable 119. The far end TTY device 112 strips the TTY tone from the analog signal, thus leaving the TTY characters, which the far end TTY device 112 presents to the far end user on the far end TTY display 114. The far end user may then respond to the message that is displayed by entering a message response using the far end TTY keyboard 116. And messaging transpires back and forth until the end of conversation, when both users terminate communication.

Thus, as described above, the deaf or otherwise hearing impaired individuals are able to exchange written messages over communication networks that principally provide for voice communications by using TTY devices 102, 112. Historically, these devices 102, 112 were provided to perfect communications for the deaf over the public switched telephone network (PSTN), and these devices 102, 112 are not compatible with newer internet protocol (IP) networks, which provide for texting between devices that are IP network compatible.

As one skilled in the art will appreciate, advances have been made over the configuration of FIG. 1 that allow a deaf person to communicate with a hearing person on by using a human relay operator. For example, as a requirement of the Americans with Disabilities Act (ADA), many businesses must allow clients with hearing disabilities access to telephone services and a free nationwide relay network was established to handle voice-to-TTY and TTY-to-voice calls. Accordingly, a business must provide a TTY device 102, 112 to any user that requests. A relay operator with a TTY device 102, 112 receives the call from a TTY user having another TTY device 102, 112, and then the relay operator places a call a number specified by the TTY user. The TTY user types the message into his/her TTY device 102, 112, and the operator relays the message by voice to party at the other end of the call. The operator then listens to the party's response, and types the response back to the TTY user.

Thus, only one of the ends shown in FIG. 1 may comprise a TTY device 102, 112, and the other end may comprise a hearing user employing either a wireless communication device 110, 120 or a landline telephone. In addition, though a single base station 130 is shown, such is representative of virtually any communication network that allows for TTY communication, where one of the ends employ a wireless communication device 110, 120 that is coupled to a TTY device 102, 112, for it is not the purpose of this application to present an in-depth discussion of all of the networks that allow for TTY telecommunication. Since technology has evolved to the extent that more and more users have replaced their landlines with wireless communication devices 110, 120, it is the interface between the TTY device 102, 112 and its corresponding wireless communication device 110, 120 that is of interest to the present application.

Referring now to FIG. 2, a block diagram is presented depicting details of the present day near end TTY communication equipment 200, such as is discussed above with reference to FIG. 1. If far end communication equipment (not shown) is substantially similar to the near end TTY communication equipment 200, then the block diagram is also representative of the far end communication equipment.

The communication equipment 200 may include a TTY device 202 that is coupled to a wireless communication device 208 via an analog cable 210. The analog cable 210 may comprise any of a number of interface cables presently available from wireless communication device manufacturers for interface to a TTY device 202.

The TTY device 202 includes a display 204 and a keyboard (or “keypad”) 206. The display 204 has an analog-to-digital converter (ADC) 243 that receives analog signals from the analog cable 210. The display 204 also has a TTY tone detector 242 that is coupled to the ADC 243 and that provides messages to a presentation area 241 on the display 204.

The keypad 206 includes message storage 261 that is coupled to a TTY tone generator 262. The TTY tone generator 262 is coupled to a digital-to-analog converter (DAC) 263 within the keypad 206. The DAC 263 provides analog signals to the analog cable 210.

The communication device 208 has an ADC 291 that receives analog signals from the analog cable 210 and that is coupled to a TTY tone detector 292. The TTY tone detector 292 generates a wireless transmission frame 293 having TTY characters 293 embedded therein. The transmission frame 293 is provided to a transmission modem 295, which is coupled to a transceive antenna 286.

The communication device 208 also has a reception modem 285 that is coupled to the antenna 286, and which generates a reception frame 283 having TTY characters 284 embedded therein. The reception frame 283 is provided to a TTY tone generator 282, which is coupled to a DAC 281. Analog signals generated by the DAC 281 are routed to the TTY device 202 via the analog cable.

In operation, a far end user (not shown) may transmit a message, “Hello Tom, this is Jim” over a series of PSTN, circuit-switched, and/or wireless voice networks, ultimately being transmitted from a nearby base station (not shown) to the near end communication device 208. According to network protocol, a modulated message is received by the antenna 286 and is provided to the RX modem 285. The modem 285 demodulates the received modulated message and converts it to a the reception frame 283 that includes the TTY characters 284 comprising the message. The communication device 208 may be set to a TTY mode, and thus the reception frame 283 is provided to the TTY tone generator 282, which embeds a TTY tone into the frame to indicate the presence of a message for the TTY device 202. The frame 283 with tone is converted to an analog signal containing the message by the DAC 281, and the analog signal containing the message is transmitted over the cable 210 to the TTY device 202.

Within the TTY device 202, the ADC 243 receives the analog signal containing the message to a digital stream and provides the digital stream to the TTY tone detector 242. The TTY tone detector 242 extracts the TTY tone from the digital stream and provides the remaining TTY characters 283 to the presentation area 241 of the display 204. Thus, “Hello Tom, this is Jim” is presented visually to the near end user.

The near end user may respond with a response message, “Hey Jim, how are you?” by entering it into the message stores 281 via keystrokes on the keypad 206. The response message is provided to the TTY tone generator 262, which inserts a TTY tone into the response message. The response message with tone is converted by the DAC 263 to an analog response signal, which is transmitted back to the communication device 208 over the analog cable 210.

The analog response signal is converted by the ADC 291 to a digital stream, and the stream is provided to the TTY tone detector 292, which formats the stream into one or more frames for transmission over the wireless network. The tone detector also inserts a TTY character 294 into the one or more frames to indicate that the signal being transmitted is destined for a compatible TTY device (not shown).

The one or more frames are provided to the TX modem 295, which modulates the one or more frames according to protocol for transmission through the antenna 286 to the nearby base station. Thus, the far end user will receive the response message, “Hey Jim, how are you?”

The present inventor has observed that present day TTY communication equipment is disadvantageous and limiting in several respects. First, deaf or otherwise hearing-impaired users of wireless devices, such as the communication device 208 of FIG. 2, are required to purchase, maintain, and travel with a TTY device, such as the TTY device 202 of FIG. 2, in order to place and receive phone calls over circuit-switched (or substantially similar) network links. In addition to the TTY device, these users are also required to purchase, maintain, and travel with an analog cable, such as the analog cable 210 of FIG. 2. As one skilled in the art will appreciate, traveling with such equipment is costly and cumbersome at best.

The present inventor has also observed that many wireless devices such as, but not limited to, mobile telephones, smartphones, and tablet computers, already exhibit elements that are required to enter and display TTY messages, and it is therefore an object of the present invention to eliminate the need to purchase, maintain, and travel with a TTY device for users of wireless devices that include keypad and display elements.

The present invention overcomes the above noted disadvantages and limitations, and others, of present day TTY communication equipment by providing apparatus and methods for employing a virtual TTY application manager within a wireless communication device that is capable of transmitting and receiving TTY messages over a circuit-switched or substantially similar network link. The present invention will now be discussed with reference to FIGS. 3-5.

Turning to FIG. 3, a block diagram is presented featuring virtual TTY communication equipment 300 according to the present invention. The virtual TTY communication equipment 300 may include a near end wireless device having a virtual TTY device manager 302 disposed therein. The wireless device may include a display 304 and a keyboard 306. The display 304 and keyboard 306 are coupled to a virtual TTY application manager 308. In one embodiment, the keyboard 306 is a mechanical keypad having key characters allowing for entry of TTY messages. In another embodiment, the keyboard 306 is a virtual keypad, as is exhibited by many present day smartphones and tablet computers. The keyboard 306 may by a QWERTY configuration or may be configured as a telephone keypad via which TTY messages may be entered conventionally or using T9™ text input protocol. The display may be a plurality of character fields or may be embodied as a full-screen display such as, but not limited to, a light-emitting diode (LED) display.

The near end wireless communication device communicates with a far end wireless communication device having a virtual TTY device manager 312 disposed therein over a wireless network which, for clarity purposes, is depicted as a simple cellular base station 320. The far end wireless communication device, like the near end wireless communication device, comprises a display 314 and a keyboard 316. The display 314 and keyboard 316 are coupled to a virtual TTY application manager 318. The near and far end devices need not be identical in configuration, but they function in substantially similar manners.

In operation, when the devices are placed in a TTY communications mode via well known mechanisms, a near end user (not shown) uses the near end keyboard 306 to enter a TTY message for transmission to a far end user (not shown) over the wireless network. The message may be displayed on the near end display 304 as it is being transmitted and may be retained (say, for conversation history) afterward. In contrast to present day mechanisms, the near end virtual TTY device manager 302 converts the message to a packetized signal for transmission as a TTY message over the wireless network by TTY transmission elements (not shown) in the near end device.

The near end wireless communication device transmits the packetized signal carrying the message over the wireless network via conventional TTY message transmission techniques that involve insertion of a TTY tone into the transmission that indicates the contents of the analog signal contains TTY characters, i.e., those characters entered via the near end keyboard 306 by the near end user. The analog signal is thus routed over the network via known circuit-switched mechanisms, where it is delivered to the far end wireless communication device.

The TTY reception elements (not shown) in the far end wireless communication device provide the packetized signal (with TTY tone present) to the far end virtual TTY device manager 312. The far end virtual TTY device manger 312 strips the TTY tone from the received signal, thus leaving the TTY characters, which the far end virtual TTY application manager 318 presents to the far end user on the far end display 314. The far end user may then respond to the message that is displayed by entering a message response using the far end keyboard 316. And messaging transpires back and forth until the end of conversation, when both users terminate communication.

In one embodiment, only one of the ends shown in FIG. 3 may comprise a virtual TTY device manager 302, 312, and the other end may comprise a wired or wireless communication device that is coupled to a TTY device, as is discussed above with reference to FIGS. 1-2. Alternatively, the other end may comprise a hearing user employing either a wireless communication device or a landline telephone, where TTY messages are converted to voice messages via a relay operator or substantially similar intermediary. In addition, though a single base station 320 is shown, such is representative of virtually any communication network that allows for TTY communication, where one of the ends employ a virtual TTY wireless communication device 302, 312.

The virtual TTY wireless communication devices 302, 312 according to the present invention are configured to perform the functions and operations as discussed above. The virtual TTY device manager 302, 312 may comprise hardware logic, circuits, devices, or microcode (i.e., micro instructions or native instructions), or a combination of hardware logic, circuits, devices, or microcode, or equivalent elements that are employed to execute the functions and operations according to the present invention as noted. The elements employed to accomplish these operations and functions within the virtual TTY device manager 302, 312 may be shared with other logic, circuits, microcode, etc., that are employed to perform other functions and/or operations within the virtual TTY device manger 302, 312. According to the scope of the present application, microcode is a term employed to refer to a plurality of micro instructions. A micro instruction (also referred to as a native instruction) is an instruction at the level that a functional unit executes.

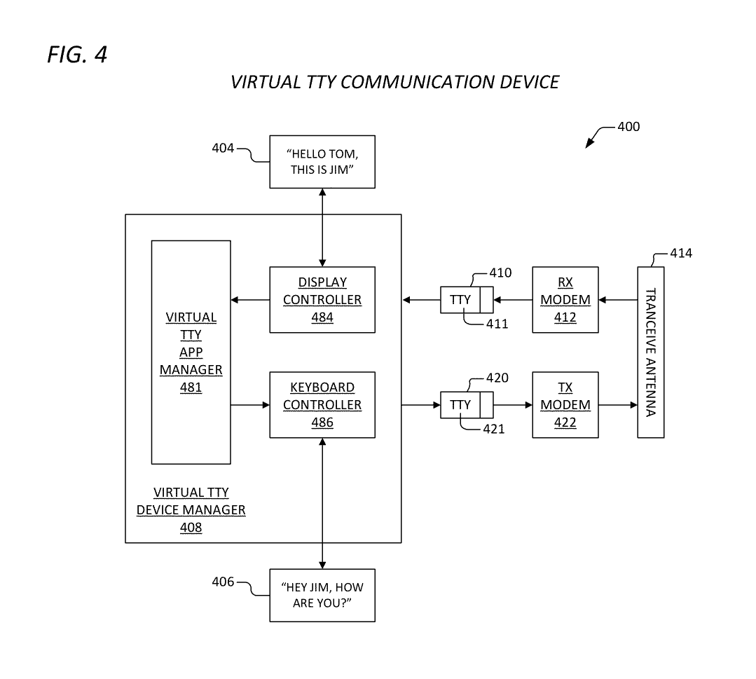

Now referring to FIG. 4, a block diagram is presented showing a virtual TTY communication device 400 according to the present invention, such as the two devices of FIG. 3. The device 400 according to the present invention may be employed as a near end device or a far end device in any of the configurations discussed above. For purposes of clarity of discussion, the device 400 will be referred to as the near end device 400.

The virtual communication device 400 may include a virtual TTY device manger 408 that is coupled to a display 404 and a keyboard (or “keypad”) 406. The virtual TTY device manager 408 generates transmission frames (or “packets”) 420 that include TTY characters 421 that are entered via the keyboard 406. The frames 420 are provided to a transmission (TX) modem 422, and the TX modem 422 is coupled to a transceive antenna 414.

The antenna 414 is coupled to a reception (RX) modem 412 that provides received frames 410 having TTY characters 411 therein to the virtual TTY device manger 408, for presentation to a near end user (not shown) via the display 404. The virtual TTY device manger 408 comprises a virtual TTY application manager 481 that is coupled to a display controller 484 and to a keyboard controller 486.

In operation, a far end user (not shown) may transmit a TTY message, “Hello Tom, this is Jim” over a series of PSTN, circuit-switched, and/or wireless voice networks, ultimately being transmitted from a nearby base station (not shown) to the near end device 400. According to network protocol, a modulated message is received by the antenna 414 and is provided to the RX modem 412. The modem 412 demodulates the received modulated message and converts it to a the reception frame 410 that includes the TTY characters 411 comprising the message. The virtual TTY communication device 400 may be set to a TTY mode, and thus the reception frame 410 is provided to the virtual TTY device manger 408.

The virtual TTY application manager 481 extracts the TTY characters 411 from the received frame 410 and provides the characters 411 to the display controller 484. The display controller 484 controls the display 404 such that the characters 411are displayed to the near end user. Thus, “Hello Tom, this is Jim” is presented visually to the near end user.

The near end user may respond with a response message, “Hey Jim, how are you?” by entering it via keystrokes on the keypad 406. The keyboard controller 486 thus provides the character stream of the message to the virtual TTY application manager 481. The virtual TTY application manager 481, which formats the stream into one or more frames 420 for transmission over the wireless network. The frames 420 include the message and TTY character 421 to indicate that the signal being transmitted is destined for a compatible TTY device (not shown).

The one or more frames 420 are provided to the TX modem 422, which modulates the one or more frames according to protocol for transmission through the antenna 414 to the nearby base station. Thus, the far end user will receive the response message, “Hey Jim, how are you?”

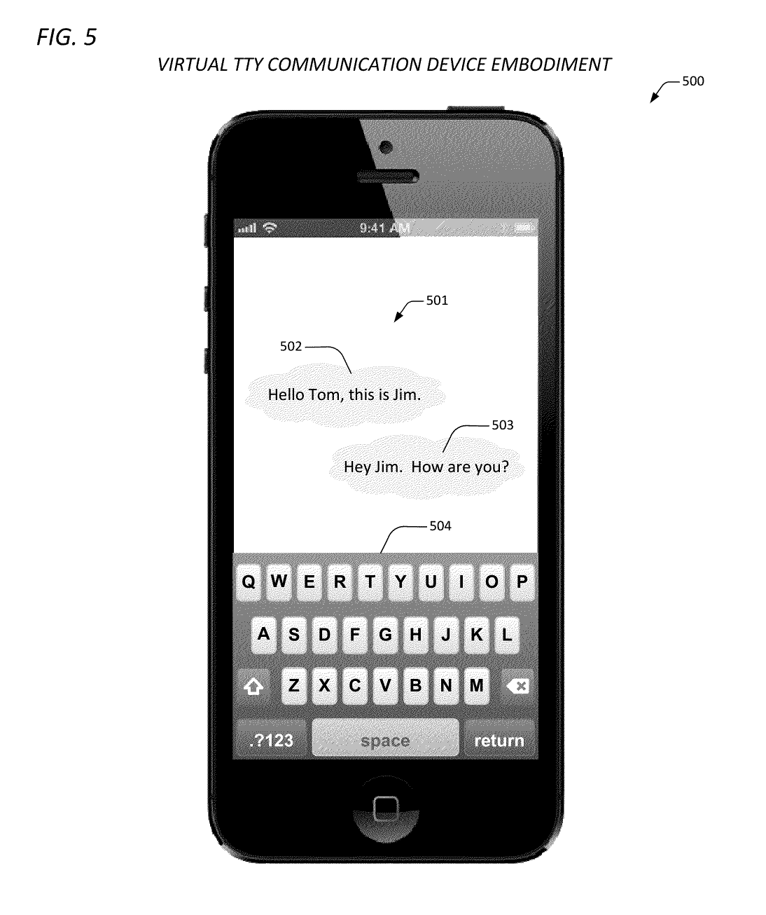

Turning now to FIG. 5, a block diagram is presented illustrating one embodiment of the virtual TTY communication device 500 according to the present invention, such as the device 400 of FIG. 4. The device 500 may be embodied as a smartphone 500 having a display 501 and a virtual touchpad 504 for entry of message characters.

For TTY messages processed by the virtual TTY element 408, the display controller 484 may present a received TTY message 502 (“Hello Tom, this is Jim”) via the display 501. As a user (not shown) enters a response message 503 (“Hey Jim. How are you?”) via the keypad 504, the virtual application manager 481 may also direct the display controller 484 to present the response message 503 to the user via the display 501.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims.

What is claimed is:

1. An apparatus for communicating teletype (TTY) messages over a wireless voice link, the apparatus comprising:
a virtual TTY device manager, disposed within a wireless communication device, configured to format first TTY messages for transmission over the wireless voice link, and configured to extract second TTY messages from frames received over the wireless voice link;
a display controller, disposed within said wireless communication device and coupled to said virtual TTY element, configured to present said second TTY messages over a display of said wireless communication device; and
a keyboard controller, disposed within said wireless communication device and coupled to said virtual TTY element, configured to enable a user to enter said first TTY messages via a keyboard of said wireless communication device.

2. The apparatus as recited in claim 1, wherein said virtual TTY device manager formats said first TTY messages by inserting TTY tone characters into packets for transmission, to indicate said first TTY messages to a far end device.

3. The apparatus as recited in claim 1, wherein said virtual TTY device manager strips TTY tone characters from packets received from a far end device, thus extracting said second TTY messages.

4. The apparatus as recited in claim 1, wherein said display controller is further configured to present said first TTY messages over said display of said wireless communication device.

5. The apparatus as recited in claim 1, wherein the wireless voice circuit is part of a wireless communication network comprising one or more base stations.

6. The apparatus as recited in claim 1, wherein said wireless communication device comprises a cellular telephone.

7. The apparatus as recited in claim 1, wherein said wireless communication device comprises a smartphone.

8. The apparatus as recited in claim 1, wherein said wireless communication device comprises a tablet computer.

9. An apparatus for communicating teletype (TTY) messages over a wireless voice link, the apparatus comprising:
a wireless communication device, configured to send first TTY messages and to receive second TTY messages over the wireless voice link, said wireless communication device comprising:
a virtual TTY device manager, configured to format said first TTY messages for transmission over the wireless voice link, and configured to extract said second TTY messages from frames received over the wireless voice link;
a display controller, coupled to said virtual TTY element, configured to present said second TTY messages over a display of said wireless communication device; and
a keyboard controller, coupled to said virtual TTY element, configured to enable a user to enter said first TTY messages via a keyboard of said wireless communication device.

10. The apparatus as recited in claim 9, wherein said virtual TTY device manager formats said first TTY messages by inserting TTY tone characters into packets for transmission, to indicate said first TTY messages to a far end device.

11. The apparatus as recited in claim 9, wherein said virtual TTY device manager strips TTY tone characters from packets received from a far end device, thus extracting said second TTY messages.

12. The apparatus as recited in claim 9, wherein said display controller is further configured to present said first TTY messages over said display of said wireless communication device.

13. The apparatus as recited in claim 9, wherein the wireless voice circuit is part of a wireless communication network comprising one or more base stations.

14. The apparatus as recited in claim 9, wherein said wireless communication device comprises a cellular telephone.

15. The apparatus as recited in claim 9, wherein said wireless communication device comprises a smartphone.

16. The apparatus as recited in claim 9, wherein said wireless communication device comprises a tablet computer.

17. A method for communicating teletype (TTY) messages over a wireless voice link, the method comprising:
via a virtual TTY device manager disposed within a wireless communication device, formatting first TTY messages for transmission over the wireless voice link, and extracting second TTY messages from frames received over the wireless voice link;
presenting the second TTY messages over a display of the wireless communication device; and
enabling a user to enter the first TTY messages via a keyboard of the wireless communication device.

18. The method as recited in claim 17, wherein the virtual TTY device manager formats the first TTY messages by inserting TTY tone characters into packets for transmission, to indicate the first TTY messages to a far end device.

19. The method as recited in claim 17, wherein the virtual TTY device manager strips TTY tone characters from packets received from a far end device, thus extracting the second TTY messages.

20. The method as recited in claim 17, wherein the display controller further presents the first TTY messages over the display of the wireless communication device.

21. The method as recited in claim 17, wherein the wireless voice circuit is part of a wireless communication network comprising one or more base stations.

22. The method as recited in claim 17, wherein the wireless communication device comprises a cellular telephone.

23. The method as recited in claim 17, wherein the wireless communication device comprises a smartphone.

24. The method as recited in claim 17, wherein the wireless communication device comprises a tablet computer.
